(19) United States
(12) Patent Application Publication
(10) Pub. No.: US 2012/0317822 A1
(43) Pub. Date: Dec. 20, 2012

(54) CUTTING EDGE STRUCTURE FOR CUTTING TOOL, AND CUTTING TOOL WITH CUTTING EDGE STRUCTURE

(75) Inventors: Hiroyuki Ochiai, Tokyo (JP); Mitsutoshi Watanabe, Tokyo (JP); Yukihiro Shimoda, Tokyo (JP)

(73) Assignee: IHI Corporation, Tokyo (JP)

(21) Appl. No.: 13/522,667

(22) PCT Filed: Jan. 19, 2011
(86) PCT No.: PCT/JP2011/050856

§ 371 Date: Jul. 17, 2012

(30) Foreign Application Priority Data
Jan. 20, 2010 (JP) 2010-010451

(51) Int. Cl. B26B 9/00

(52) U.S. Cl. 30/350

(57) ABSTRACT

A cutting edge structure for a cutting tool including: a base member having first and second surfaces intersecting each other; and a cutting edge member supported by the base member and having higher hardness than the base member. The cutting edge member includes a coating formed by generating electric discharge between the second surface and a discharge electrode and by depositing a constituent material of the discharge electrode or a reacted substance of the constituent material on the second surface, the discharge electrode being formed by molding powder of metal, powder of a metal compound, powder of a ceramic, or powder of a mixture thereof. An edge of the coating projects from a cross ridge line between the first and second surfaces toward a distal end side of a cutting edge. The cutting edge angle is 10° to 20° inclusive.

### TECHNICAL FIELD

The present invention relates to a cutting edge structure for a cutting tool including a coating formed on a cutting edge portion, and to a cutting tool including the cutting edge structure.

### BACKGROUND ART

Japanese Patent Application Publication No. 2008-264116 discloses a kitchen knife including a coating formed on a cutting edge portion by discharge surface treatment.

### SUMMARY OF INVENTION

### Technical Problem

The above-mentioned conventional technique refers to resharpening of the cutting edge portion to bring the sharpness of the kitchen knife back to a fine condition when the cutting edging portion is worn away, but does not consider the sharpness of the kitchen knife in a state where the wear of the cutting edge portion progresses to some extent (for example, a state after a lapse of an initial wear period that is an initial stage after beginning of use). For this reason, the conventional technique has difficulty maintaining the sharpness of the kitchen knife in a fine condition after the wear of the cutting edge portion progresses to some extent.

The present invention has been made in view of the aforementioned problem and an object thereof is to provide a cutting edge structure for a cutting tool capable of maintaining fine sharpness even after wear of a cutting edge portion progresses to some extent, and to provide a cutting tool including the cutting edge structure.

### Solution to Problem

A first aspect of the present invention is a cutting edge structure for a cutting tool comprising: a base member; and a cutting edge member being supported by the base member and having higher hardness than the base member, wherein the base member includes a first surface and a second surface intersecting the first surface, the cutting edge member includes a coating formed by generating electric discharge between the second surface and a discharge electrode and by depositing a constituent material of the discharge electrode or a reacted substance of the constituent material on the second surface by using energy of the electric discharge, the discharge electrode being formed by molding powder of metal, powder of a metal compound, powder of a ceramic, or powder of a mixture thereof, and the base member and the cutting edge member are formed such that an edge of the coating projects from a cross ridge line between the first surface and the second surface toward a distal end side of a cutting edge and that a cutting edge angle is set in a range from 10° to 20° inclusive.

In addition, a second aspect of the present invention is a cutting tool comprising the aforementioned cutting edge structure.

### BRIEF DESCRIPTION OF DRAWINGS

FIG. 1 is a view showing an overall configuration of a kitchen knife of a double grind type including a cutting edge structure according to a first embodiment of the present invention.

FIG. 2 is an enlarged cross-sectional view taken along the II-II line in FIG. 1.

FIG. 3 is a view for explaining a method of forming a coating on the kitchen knife of FIG. 1 by a discharge surface treatment.

FIG. 4 is a view for explaining an influence of a cutting edge angle on a relation between a retreat amount of an edge of a base member and a projection amount of a cutting edge member, in which FIG. 4(a) shows a relation between the retreat amount of the edge of the base member and the projection amount of the cutting edge member when the cutting edge angle is relatively small and FIG. 4(b) shows a relation between the retreat amount of the edge of the base member and the projection amount of the cutting edge member when the cutting edge angle is relatively large.

FIG. 5 is a view showing a state of change in a cross-sectional shape of a cutting edge portion with the progress of wear.

FIG. 6 is a graph showing results of sharpness tests conducted by using kitchen knives including the cutting edge structure according to the first embodiment of the present invention.

FIG. 7 is a graph showing results of sharpness tests conducted by using kitchen knives having different hardness values of base members for the cutting edge portions.

FIG. 8 is a view showing sections when cutting tests are performed on frozen food by using the kitchen knife including the cutting edge structure according to the first embodiment of the present invention, in which FIG. 8(a) is a photograph of a section of frozen bacon, FIG. 8(b) is a photograph of a section of a frozen pork loin block, and FIG. 8(c) is a photograph of a section of frozen tuna.

FIG. 9 is a view showing an overall configuration of a kitchen knife of a single grind type including a cutting edge structure according to a second embodiment of the present invention.

FIG. 10 is an enlarged cross-sectional view taken along the X-X line in FIG. 9.

### DESCRIPTION OF EMBODIMENTS

Preferred embodiments of the present invention will be described below with reference to the drawings. It is to be noted that the technical scope of the present invention shall be defined on the basis of the description of the appended claims and shall not therefore be limited only to the following embodiments. In the description of the drawings, the same constituents are designated by the same reference numerals and duplicate explanation will be omitted. It is to be also noted that dimensional proportions in the drawings may be exaggerated for the convenience of explanation and may be different from actual proportions.

Moreover, in this description, a cutting tool is a general term for a tool for cutting, severing or chipping an object with a structure called a blade. The cutting tool may include kitchen knives, knives, kogatanas, razors, gravers, sickles, chisels, planes, and the like. The kitchen knives may include a Japanese kitchen knife such as a deba bocho, an usuba bocho, a nakiri bocho, a sashimi bocho, a santoku bocho, a mioroshi hocho or a funayuki hocho, and a western kitchen knife such as a chefs knife, a paring knife, a bread knife, a sujibiki hocho, a carving knife, a slicer, a cleaver, a boning knife or a fillet knife.

### First Embodiment

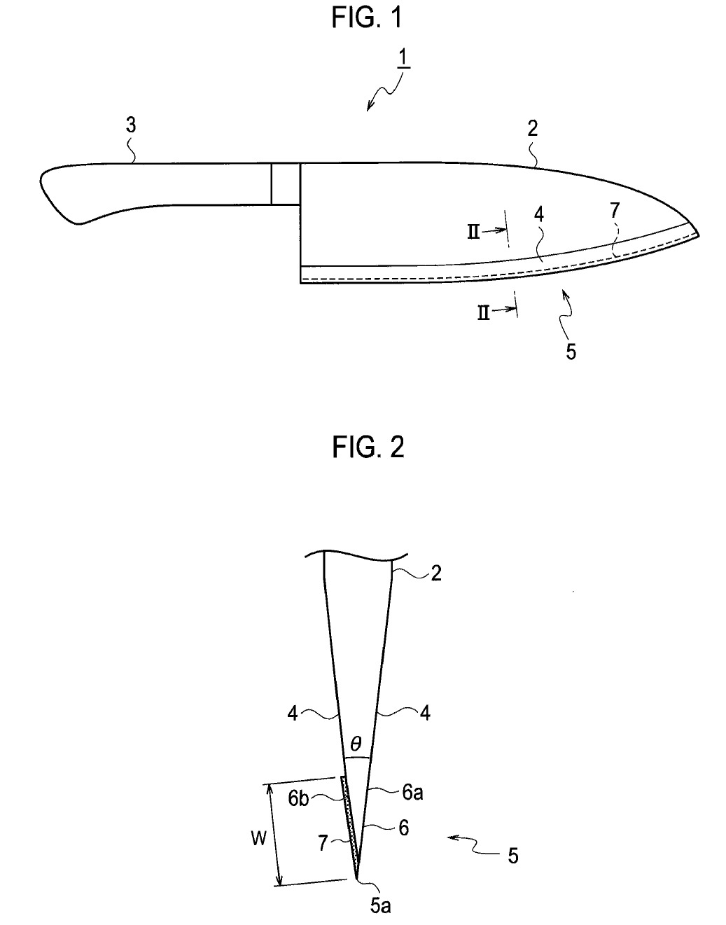

A cutting tool including a cutting edge structure according to a first embodiment of the present invention will be described with reference to FIG. 1 to FIG. 5.

A cutting tool according to the embodiment is a kitchen knife 1 of a double grind type. As shown in FIG. 1, the kitchen knife 1 includes a blade 2 and a handle 3 attached to a base portion of the blade 2. Edges 4 are provided on two surfaces of the blade 2.

The blade 2 is made of stainless steel which has excellent corrosion resistance. The stainless steel may include stainless blade steel, molybdenum vanadium steel, cobalt alloy steel, VG10 steel (manufactured by Takefu Special Steel Co., Ltd.), and the like. Besides the stainless steel, the blade 2 may be made of steel such as Aogami steel (manufactured by Hitachi Metals, Ltd.), Shirogami steel (manufactured by Hitachi Metals, Ltd.), tool steel (SK steel as defined by JIS) or chromium molybdenum steel, a material formed by attaching any of the aforementioned steel materials to a soft iron base, powder steel, a composite material, titanium, and the like.

The handle 3 is made of plastics, wood or plywood and is fixed to the blade 2 with a rivet or an adhesive. Here, the handle 3 may be formed integrally with the blade 2 or replaceably fixed to the blade 2.

FIG. 2 is a view showing a cross section which is perpendicular to a cutting edge 5a of a cutting edge portion 5 which is a region close to a cutting edge of the blade 2.

As shown in FIG. 2, the cutting edge portion 5 includes a base member 6 having a front surface 6a (a first surface) and a back surface 6b (a second surface), and a cutting edge member 7 supported by the base member 6. In this embodiment, the base member 6 is made of the same stainless steel as the blade 2. Instead, the base member 6 of the cutting edge portion 5 may be made of a different material from a body portion of the blade 2.

The cutting edge member 7 includes a coating 7 having higher hardness than that of the base member 6, which is formed in a strip-shaped region near the cutting edge 5a on the back surface 6b of the base member 6 by a discharge surface treatment.

The discharge surface treatment is a surface treatment in which electric discharge is generated between a discharge electrode and a workpiece (a parent material) in a processing liquid such as electrically insulative oil or in air, and discharge energy therefrom is used to form, on a processed surface of the workpiece, a wear-resistant coating made of an electrode material or a reacted substance of the electrode material obtained by the discharge energy.

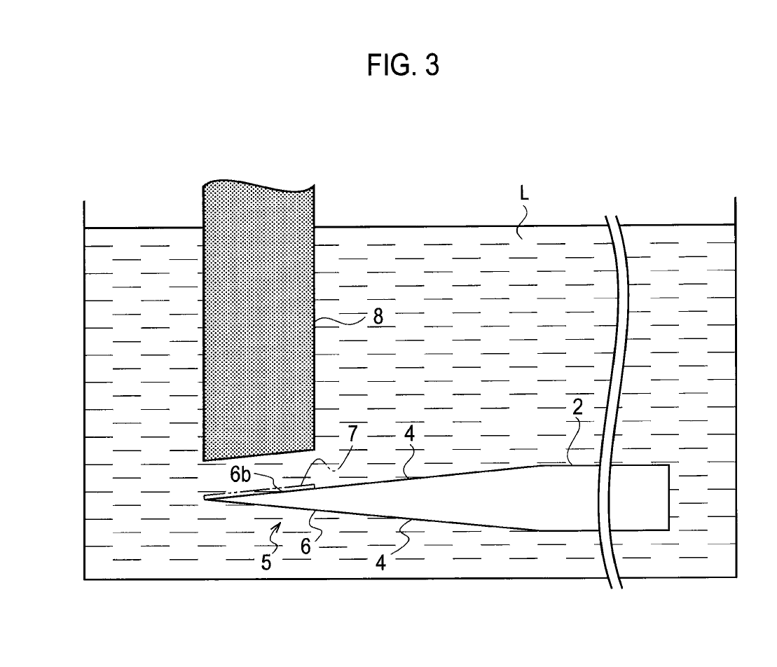

In this embodiment, as shown in FIG. 3, the coating 7 provided with asperities on a surface is formed as follows: a rod-shaped discharge electrode 8 having a width on a tip end substantially corresponding to a width of the region for forming the coating on the back surface 6b of the base member 6 is used, and pulse discharge is generated between the discharge electrode 8 and the back surface 6b of the base member 6 while the cutting edge portion 5 is moved relative to the discharge electrode 8 in an electrically insulative processing liquid L; and the constituent material of the discharge electrode 8 or the reacted substance of the constituent material is deposited on the back surface 6b of the base member 6 by use of the discharge energy. When a discharge electrode (not shown) having a shape that conforms to the shape of the cutting edge portion 5 of the blade 2 is used instead of the rod-shaped discharge electrode 8, the blade 2 does not have to be moved relative to such a discharge electrode.

Here, the discharge electrode 8 is a green compact electrode (including a green compact electrode subjected to a heat treatment) formed by compression molding or injection molding powder of metal, powder of a metal compound, powder of a ceramic, or powder of a mixture of multiple types among these materials. The discharge electrode 8 may also be formed of a compact molded by slipcasting, spray forming, and so forth.

The above-mentioned metal, metal compound or ceramic may include titanium (Ti), silicon (Si), cubic boron nitride (cBN), titanium carbide (TiC), titanium nitride (TiN), titanium aluminum nitride (TiAlN), titanium boride (TiB), titanium diboride (TiB₂), tungsten carbide (WC), chromium carbide (Cr₃C₂), silicon carbide (SiC), zirconium carbide (ZrC), vanadium carbide (VC), boron carbide (B₄C), silicon nitride (Si₃N₄), stabilized zirconium oxide (ZrO₂—Y), alumina (Al₂O₃), and the like.

Regarding the discharge electrode formed by compression molding the powder of the mixture, the discharge electrode can be provided with appropriate electrical conductivity by properly adjusting an added amount of powder of a conductive material. Meanwhile, regarding the discharge electrode formed by compression molding the powder of the ceramic, the discharge electrode can be provided with appropriate electrical conductivity by using the powder of the ceramic having surfaces coated with a conductive material as the raw material.

Furthermore, the discharge electrode 8 may be formed by compression molding of powder of a material such as Si or Ti which can easily form carbide or may be formed of metal silicon (Si crystal). In such a case, when electric discharge is generated in processing oil containing hydrocarbon such as kerosene, the electrode material reacts with the discharge energy, and the reacted substance (such as SiC or TiC) is deposited on the surface of the base member 6 and forms the coating 7.

Discharge conditions of the pulse discharge in the discharge surface treatment can be appropriately set depending on the raw material of the discharge electrode 8, quality of the base member 6, the thickness of coating 7, surface roughness of the coating 7, and so forth. Usually, a peak current is set in a range from 1 A to 30 A, inclusive and a pulse width is set in a range from 1 μs to 20 μs, inclusive. Here, the discharge conditions are preferably adjusted to a peak current of 5 A to 20 A, inclusive and a pulse width of 2 μs to 20 μs, inclusive in order to increase adhesion strength of the coating 7 while suppressing damages on the base member 6. Meanwhile, discharge conditions for providing the coating 7 with targeted surface roughness can be appropriately set in accordance with a method described in Japanese Patent Application Publication No. 2008-264116, for example.

In this embodiment, surface roughness Ra of the coating 7 is set equal to or above 0.8 μm or preferably equal to or above 1.0 μm. If the surface roughness of the coating 7 is below 0.8 μm, it is difficult to form serrated asperities on the cutting edge 5a of the kitchen knife 1. The surface roughness Ra is the arithmetic mean roughness as defined in Japanese Industrial Standard (JIS-B-0601:2001).

The cutting edge portion 5 of this embodiment is formed as follows: the coating 7 provided with the asperities by depositing the constituent material of the discharge electrode 8 or the reacted substance of the constituent material is formed on the back surface 6b of the base member 6, by the discharge surface treatment; and thereafter, a surface of the cutting edge portion 5 (the front surface 6a of the base member 6 and a surface on a front side of the coating 7 (on the right side in FIG. 2 or a lower side in FIG. 3)) are ground with a diamond whetstone and the like. In this way, an edge of the coating 7 is formed to project from an edge of the base member 6 (a cross ridge line between the front surface 6a and the back surface 6b) toward a distal end side of the cutting edge portion 5 (toward a distal end side of the cutting edge), and the coating 7 thus functions as a cutting edge member.

In this embodiment, a width w of the coating 7 is set at 1 mm to 10 mm, inclusive or preferably 3 mm to 5 mm, inclusive. Note that the width w of the coating 7 below 1 mm leads to a decrease in the available number of resharpening the cutting edge portion 5.

Furthermore, in this embodiment, a cutting edge angle θ is formed to be 10° to 20°, inclusive. If the cutting edge angle θ is below 10°, rigidity of the cutting edge portion is reduced, whereby the cutting edge portion bends easily and may be difficult to use. When the cutting edge angle θ exceeds 20°, it is difficult to maintain the sharpness of the kitchen knife 1 in a fine condition. The cutting edge angle θ is set more preferably at 10° to 15°, inclusive or even more preferably 10° to 12°, inclusive. Even a small force can exert a large wedge effect when the cutting edge angle θ is equal to or below 15° or can exert even a larger wedge effect when the cutting edge angle θ is equal to or below 12°. Thus it is possible to further reduce a force required for cutting in the case of cutting frozen food without partially thawing the frozen food as will be described later. Here, the cutting edge angle θ may be smaller than 10° when the kitchen knife 1 is used exclusively for objects to be cut that can be cut out with even a smaller force.

In this description, the cutting edge angle θ is an angle at the cutting edge portion 5 defined by the front surface 6a of the base member 6 and by the back surface 6b of the base member 6 (or the outermost surface of the coating 7). When the front surface 6a of the base member 6 and the back surface 6b of the base member 6 (or the outermost surface of the coating 7) are formed into curved surfaces as found in a convex grind blade or the like, the cutting edge angle θ is an angle defined by a tangential plane to the front surface 6a at a front end edge of the front surface 6a of the base member 6 and by a tangential plane to the back surface 6b (or the outermost surface of the coating 7) at a front end edge of the back surface 6b of the base member 6 (or the outermost surface of the coating 7). Meanwhile, a smaller blade (koba) may be provided at the distal end of the cutting edge portion 5. In this case, the cutting edge angle θ is an angle defined by a tangential plane to the front surface 6a of the base member 6 on a cross ridge line between the front surface 6a of the base member 6 and a front-side blade surface of the smaller blade (koba) and by a tangential plane to the back surface 6b of the base member 6 (or the outermost surface of the coating 7) on a cross ridge line between the back surface 6b of the base member 6 (or the outermost surface of the coating 7) and a back-side blade surface of the smaller blade (koba).

Moreover, in the kitchen knife 1 according to this embodiment, hardness of the base member 6 is set at HRC 27 to HRC 60, inclusive in terms of Rockwell hardness.

Next, the operation and effect of this embodiment will be described.

Generally, the cutting edge angle θ is one of important factors along with the rough shape on the cutting edge 5a and the hardness thereof, which govern the sharpness of the cutting tool. In particular, the size of the cutting edge angle θ governs the wedge effect that advances a cleavage when the cutting tool cuts an object to be cut.

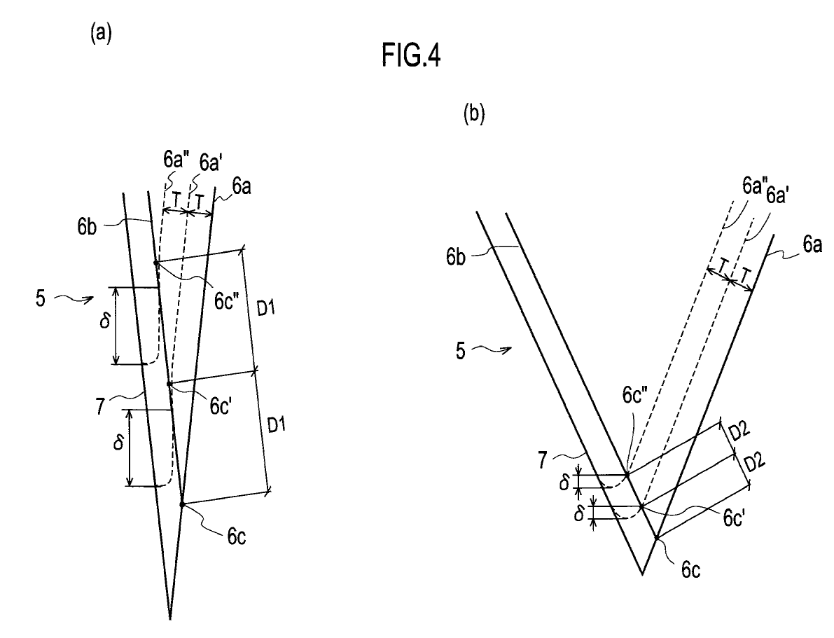

However, for the cutting edge portion 5 using the coating 7 as the cutting edge member or for the cutting tool provided with the cutting edge portion 5, the cutting edge angle θ is more than just a factor that governs the wedge effect. Specifically, the cutting edge angle θ is a major factor that determines a mode of change in the cross-sectional shape of the cutting edge portion along with the progress of wear of the cutting edge portion 5. That is, as shown in FIG. 4, along with movements of a position of the front surface 6a of the base member 6 to positions indicated with 6a′ and 6a″ in the drawing due to the progress of the wear of the cutting edge portion 5, a position of a front end edge 6c of the front surface 6a gradually retreats to positions indicated with 6c′ and 6c″ in the drawing. Here, when the cutting edge angle θ is relatively small, a retreat amount D1 of the front end edge 6c against a wear amount T of the front surface 6a of the base member 6 becomes relatively larger as shown in FIG. 4(a). Accordingly, a projection amount δ of the cutting edge member 7 may be too large whereby the cutting edge member 7 may lack strength and cause a nicked edge and the like as a consequence. This problem leads to an increase in the number of times of sharpening the cutting edge portion 5 and eventually to a shorter life of the kitchen knife 1. On the other hand, when the cutting edge angle θ is relative large, a retreat amount D2 of the front end edge 6c against the wear amount T of the front surface 6a of the base member 6 becomes relatively smaller as shown in FIG. 4(b). Accordingly, the projection amount δ of the cutting edge member 7 tends to be too small whereby the sharpness of the cutting tool may be deteriorated.

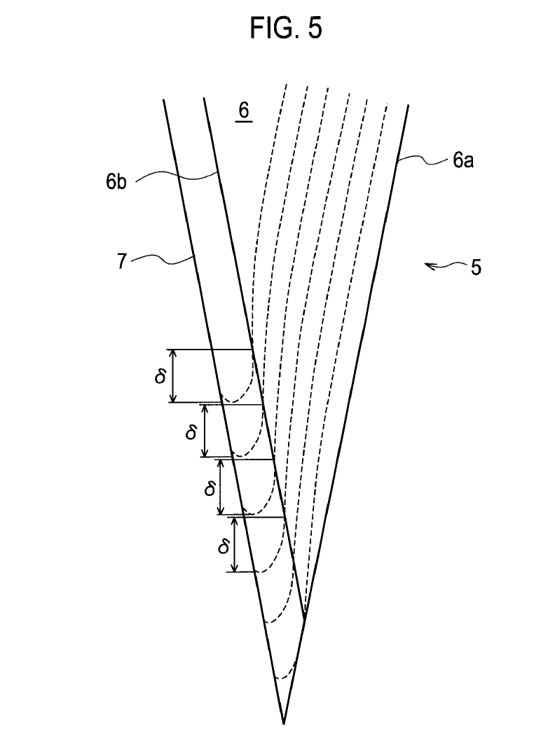

According to the kitchen knife 1 of this embodiment, the cutting edge angle θ of the cutting edge portion 5 is formed to be 10° to 20°, inclusive. For this reason, although there is a gap between a retreat rate at an edge of the cutting edge member 7 due to the wear of the cutting edge member 7 and a retreat rate at an edge of the base member 6 due to the wear of the base member 6 at an initial stage after beginning of use (an initial wear period), the retreat rate at the edge of the cutting edge member 7 due to the wear of the cutting edge member 7 and the retreat rate at the edge of the base member 6 due to the wear of the base member 6 reach an equilibrium when the projection amount δ of the cutting edge member 7 becomes an optimum amount (after a lapse of the initial wear period) as the wear progresses to some extent. Accordingly, even when the wear progresses thereafter, the projection amount δ of the cutting edge member 7 is maintained at the optimum amount as shown in FIG. 5, and the sharpness of the kitchen knife 1 is maintained in a fine condition. Moreover, since the projection amount δ of the cutting edge portion 7 is maintained at the optimum amount as described above, it is possible to suppress occurrence of a nicked edge or the like while ensuring the strength and rigidity of the edge of the cutting edge member 7. In this way, the number of times of sharpening the cutting edge portion 5 is suppressed and the life of the kitchen knife 1 is extended.

In this description, the projection amount δ means a length from the cross ridge line between the front surface 6a and the back surface 6b of the base member 6 to the distal end of the cutting edge member 7. In the state after the lapse of the initial wear period where the cutting edge portion 5 is worn away to some extent, the projection amount δ means a length from an edge of an interface between the base member 6 and the coating 7 to the distal end of the cutting edge member 7.

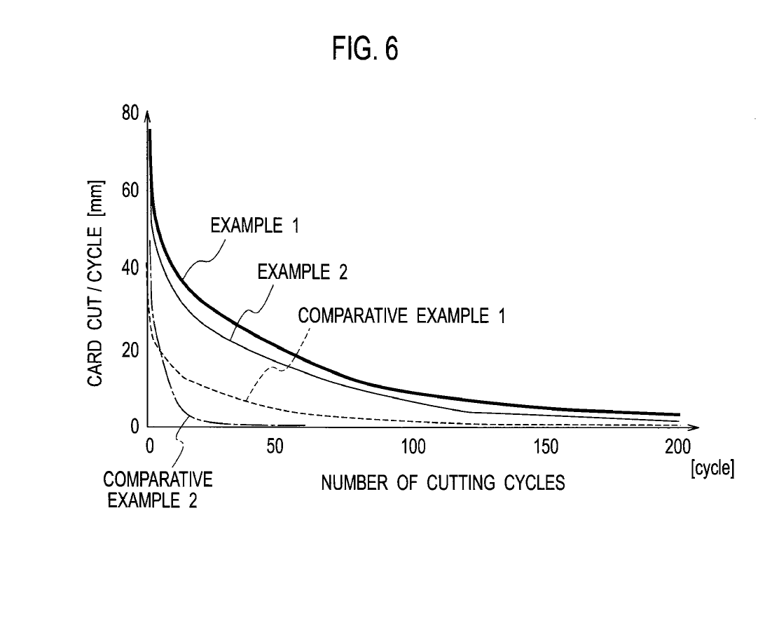

In order to evaluate sharpness of kitchen knives 1 of this embodiment, sharpness tests have been conducted in accordance with a method determined by the International Standard (IS08442.5) by using a kitchen knife 1 (Example 1) with the cutting edge angle θ formed at 10° and a kitchen knife 1 (Example 2) with the cutting edge angle θ formed at 20° in accordance with this embodiment, a kitchen knife (Comparative Example 1) with the cutting edge angle θ formed at 40°, and a kitchen knife (Comparative Example 2) with the cutting edge angle θ formed at 20° but not provided with the cutting edge member (the coating) 7. A cutting test machine manufactured by CATRA was used as a test machine. As for test conditions, a test load was set to 50 N, a stroke was set to 40 mm, a traveling speed was set to 50 mm/sec., and paper containing 5% of silica was used as an object to be cut. Obtained results are shown in FIG. 6. Note that the horizontal axis in FIG. 6 indicates the number of test cycles and the vertical axis indicates the number of cut sheets per cycle. Meanwhile, in FIG. 6, a heavy solid line indicates Example 1, a thin solid line indicates Example 2, a broken line indicates Comparative Example 1, and a chain line indicates Comparative Example 2, respectively.

In Comparative Example 1 in FIG. 6, a decreasing rate of the number of cut sheets per cycle becomes smaller (deterioration in the sharpness is suppressed) after the number of test cycles reaches about 5 cycles. However, the number of cut sheets per cycle drops to approximately two sheets around 100 cycles. On the other hand, in Example 1 and Example 2, the decreasing rates of the numbers of cut sheets per cycle become smaller (deterioration in the sharpness is suppressed) after the number of test cycles reaches about 10 cycles and the numbers of cut sheets per cycle are maintained thereafter at relatively high levels (about 3 to 4 times as high as Comparative Example 1) until about 150 cycles. In other words, it is confirmed that Example 1 and Example 2 according to this embodiment can maintain higher sharpness for a longer period after the lapse of the initial wear period as compared to Comparative Example 1.

Although Comparative Example 2 has the cutting edge angle θ of 20°, the number of cut sheets per cycle drops to about 2 sheets when the number of test cycles reaches about 20 cycles. On the other hand, Example 2 maintains the number of cut sheets per cycle about 10 times as high as that of Comparative Example 2 throughout the entire cycles. It is thus confirmed that the kitchen knife 1 of this embodiment significantly improves the sharpness by providing the coating (the cutting edge member) 7 on one of the surfaces of the base member 6 at the cutting edge portion 5.

Meanwhile, when the cutting edge angle θ of a conventional kitchen knife is set equal to or below 20°, the kitchen knife would lack rigidity at the cutting edge portion, and would cause a nicked edge or accelerate wear at the edge of the cutting edge portion, thereby posing a problem that the cutting blade portion requires sharpening at short intervals, for example. In the above-described tests, the deterioration in the sharpness of Comparative Example 2 observed soon after starting the test is conceivably attributable to these factors. From the results of the above-described sharpness tests, it is also confirmed that the structure of the cutting edge portion 5 of this embodiment can ensure sufficient rigidity and strength for the cutting edge portion 5.

In the meantime, for the cutting edge portion 5 using the coating 7 as the cutting edge member or for the cutting tool provided with the cutting edge portion 5, the hardness of the base member 6 is more than just a factor that governs the sharpness of the cutting tool, the number of times of sharpening, a tendency to cause a nicked edge, and so forth. Specifically, the hardness of the base member 6 is a major factor next to the aforementioned cutting edge angle θ, which determines the mode of change in the cross-sectional shape of the cutting edge portion along with the progress of wear of the cutting edge portion 5. That is, if the base member 6 is too hard, the edge of the base member 6 retreats less than the cutting edge member 7 and the projection amount S of the cutting edge member 7 becomes too small. Thus the sharpness of the cutting tool is deteriorated. On the other hand, if the base member 6 is too soft, the edge of the base member 6 retreats more than the cutting edge member 7 and the projection amount of the cutting edge member 7 becomes too large. Thus the cutting edge member 7 may lack strength and cause a nicked edge and the like as a consequence. This problem leads to an increase in the number of times of sharpening the cutting edge portion 5 and eventually to a shorter life of the kitchen knife 1.

According to the kitchen knife 1 of this embodiment, the hardness of the base member 6 is set at HRC 27 to HRC 60, inclusive. Therefore, a wear rate of the base member 6 relative to a wear rate of the cutting edge member 7 is maintained at an appropriate value after the lapse of the initial wear period whereby the projection amount δ of the cutting edge member 7 is always maintained at the optimum value during the progress of the wear. Thus the sharpness of the kitchen knife 1 is maintained in a fine condition. In this way, the number of times of sharpening the cutting edge portion 5 is suppressed and the life of the kitchen knife 1 is extended. Here, the hardness of the base member 6 is set more preferably at HRC 40 to HRC 50, inclusive.

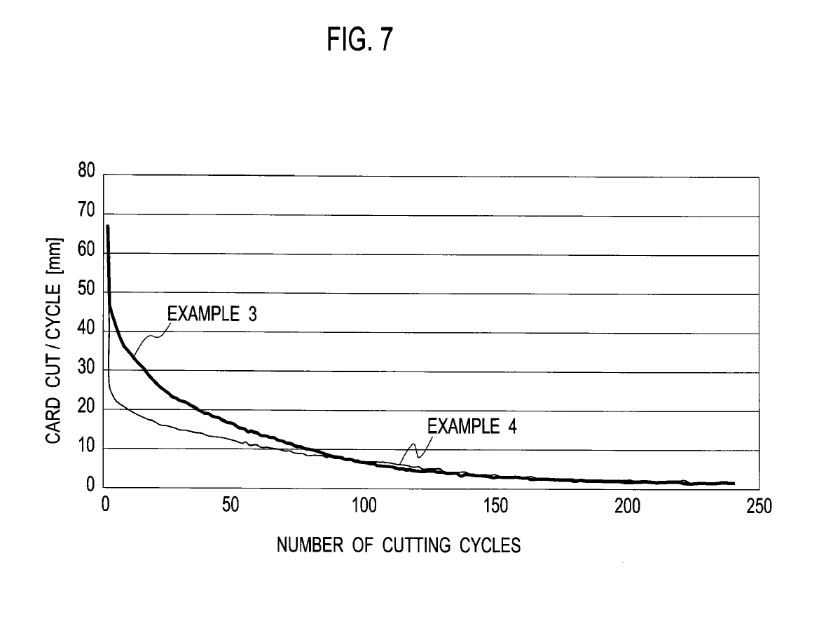

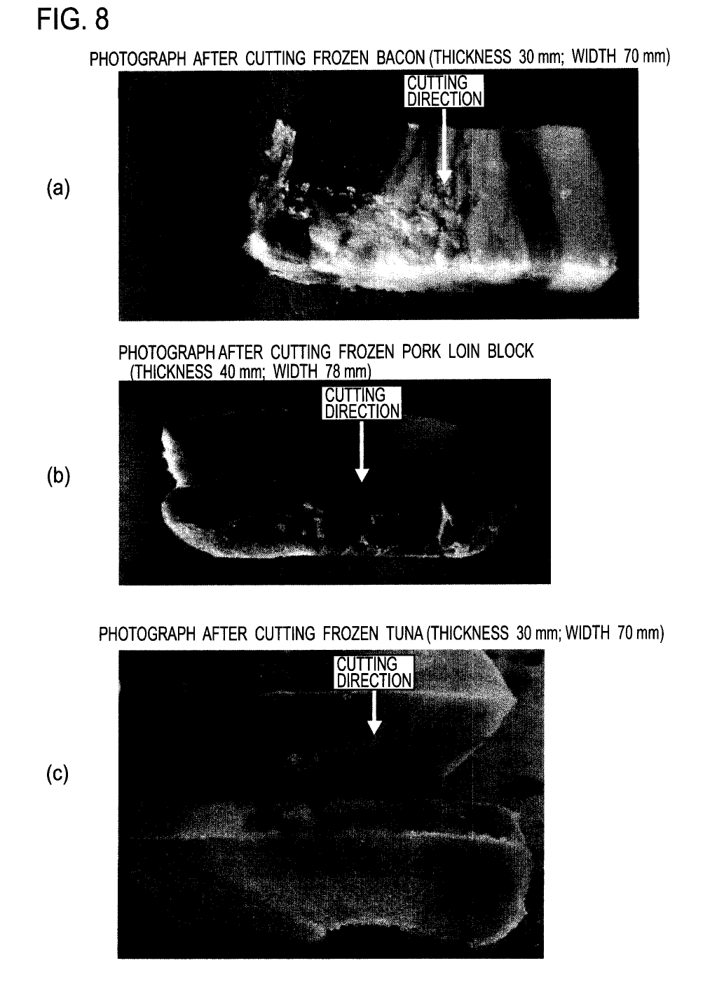

In order to evaluate a relation between the sharpness of kitchen knife 1 and the hardness of the base member 6, sharpness tests have been conducted in accordance with the method determined by the International Standard (IS08442.5) by use of a kitchen knife (Example 3) using quenched stainless steel (hardness HRC 60) as the base member 6 and having the cutting edge angle θ of 20° and a kitchen knife (Example 4) using stainless steel without undergoing a quenching process (hardness HRC 27) as the base member 6 and having the cutting edge angle θ of 20°. The test machine and test conditions used therein are similar to those used in the above-described sharpness tests conducted for Example 1 and Example 2. Obtained results are shown in FIG. 7. Note that the horizontal axis in FIG. 7 indicates the number of test cycles and the vertical axis indicates the number of cut sheets per cycle. Meanwhile, in FIG. 7, a heavy solid line indicates Example 3 and a thin solid line indicates Example 4, respectively.

As shown in FIG. 7, Example 3 with the higher hardness achieves a higher number of cut sheets per cycle (has higher sharpness) than Example 4 in the initial wear period at an initial stage after starting the tests. Nevertheless, the numbers of cut sheets per cycle of both of the examples are balanced after the number of test cycles reaches about 100 cycles, and it is confirmed that both of Example 3 and Example 4 maintain almost the same degree of high sharpness thereafter. In other words, it is confirmed that the fine sharpness can be maintained for a long time after the lapse of the initial wear period when the hardness of the base member 6 is set in the range from HRC 27 and HRC 60, inclusive. Meanwhile, the number of cut sheets per cycle of Example 4 is slightly greater than the number of cut sheets per cycle of Example 3 after the number of test cycles reaches about 100 cycles. This is conceivably because the hardness of the base member of Example 4 is lower than that of Example 3 and therefore the projection amount δ of the cutting edge member 7 is larger and the cutting edge is sharper in Example 4 as compared to Example 3.

Furthermore, in this embodiment, the coating 7 is provided in the strip-shaped region having the width equal to or above 1 mm from the edge of the cutting edge portion 5 (the cutting edge 5a) (in the range of 1 mm or above from the cutting edge 5a) on the back surface 6b of the base member 6. As a consequence, the wear of the back surface 6b of the base member 6 at the cutting portion 5 is sufficiently suppressed. Accordingly, the rigidity and strength of the cutting edge portion 5 can be sufficiently ensured even when the wear progresses on the front surface 6a of the base member 6. Here, the thickness of the coating 7 is equal to about 15 μm.

Meanwhile, in this embodiment, the cutting edge member 7 includes the coating 7 which is formed by the discharge surface treatment. Moreover, the coating 7 is formed as a gradient alloy layer in which the content of the raw material of the base member is gradually increased from the outermost surface toward the interface with the base member. The hardness is distributed in a gradient fashion in such a manner as to become the highest on the outermost surface (the hardness on the outermost surface of the coating 7 is usually about 1500 to 2500 in terms of micro-Vickers hardness) and to become the lowest at the interface with the base member 6 (to show the hardness which is nearly equal to the hardness of the base member 6). Specifically, at the edge portion of the coating 7, the wear rate in a region near the outermost surface is the lowest while the wear rate in a region near the interface with the base member 6 is the largest. Accordingly, the edge of the coating 7 shows the state in which the outermost surface side of the gradient alloy layer projects most toward the distal end side of the cutting edge when the wear of the cutting edge portion 5 progresses to some extent after the lapse of the initial wear period, and a layer on the outermost surface side of this coating 7 forms the sharp cutting edge of the cutting edge portion 5.

Moreover, the fine asperities are formed on the coating 7 and the surface roughness Ra is set equal to or above 8 μm. Accordingly, the rough shape on the cutting edge 5a is always regenerated into the serrated shape having the asperities in the size corresponding to the surface roughness as the edge portion of the coating 7 is worn away and the layer on the outermost surface side of the coating 7 projects most toward the distal end side. In this way, the fine sharpness of the kitchen knife 1 is maintained for a long period.

In addition, the kitchen knife 1 of this embodiment succeeds in achieving an unexpected effect that the kitchen knife 1 can easily cut frozen food such as frozen fish food or frozen meat food in a short time without partially thawing the frozen food.

The frozen food is analogous to fiber-containing ice. The kitchen knife 1 of this embodiment can cut the frozen food by: efficiently cutting the fibers using the serrated rough shape regenerated on the cutting edge 5a by way of the wear; and efficiently breaking the ice with the strong edge effect exerted by the relatively small cutting edge angle θ of 10° to 20°, inclusive. Accordingly, the aforementioned unexpected effect can conceivably be achieved by the synergy of the cut of the fibers using the serrated rough shape on the cutting edge 5a and the strong wedge effect attributed to the small cutting edge angle θ.

In order to evaluate the sharpness of the kitchen knife 1 when cutting the frozen food, sharpness tests (cutting tests) have been conducted by using a kitchen knife (Example 5) of the double grind type having the cutting edge angle θ of 20°, a kitchen knife (Example 6) of the double grind type having the cutting edge angle θ of 15°, and a kitchen knife (Example 7) of the double grind type having the cutting edge angle θ of 10°. The raw material of the base members 6 of the kitchen knives according to Examples 5 to 7 is chromium molybdenum steel (Cr13MoV) for cutting tools which has the hardness of HRC 50. The raw material of the coating 7 is TiC. Frozen bacon (one of the frozen meat food), a block of frozen pork loin (one of the frozen meat food), and frozen tuna (one of the frozen fish food) are used as the frozen food serving as objects to be cut, and average values of time required for cutting those objects by seven average housewives were examined. Obtained results are shown on Table 1.

TABLE 1

| | Object to be cut | | |
|---|---|---|---|
| | Frozen Bacon | Frozen Pork Loin Block | Frozen Tuna |
| Example 5 | 3.5 sec. | 9.0 sec. | 59 sec. |
| Example 6 | 3.0 sec. | 8.0 sec. | 37 sec. |
| Example 7 | 1.5 sec. | 6.5 sec. | 20 sec. |

As shown on Table 1, in the case of cutting the above-mentioned frozen food by using a commercially available steel kitchen knife without partially thawing the frozen food, the frozen bacon requires about 5 sec., the frozen pork loin block requires about 12 sec., and the frozen tuna requires about 70 sec. On the other hand, it is confirmed that the kitchen knives 1 according to Examples 5 to 7 described above can significantly shorten the time required for cutting and reduce the force required for cutting. In addition, it is also confirmed that Example 6 with the cutting edge angle θ of 15° shows better sharpness than Example 5 with the cutting edge angle θ of 20°, and that Example 7 with the cutting edge angle θ of 10° shows even better sharpness than Example 6 with the cutting edge angle θ of 15°.

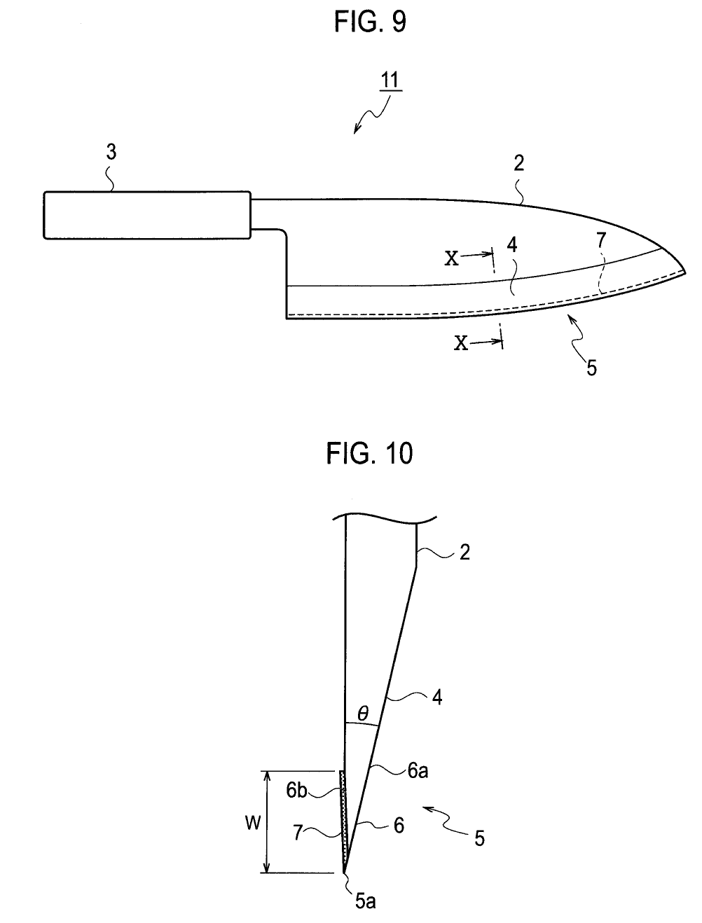

Moreover, all sections of the frozen food cut in the tests are smooth as shown in FIGS. 9(a), 9(b), and 9(c). A kitchen knife made of an iron-based material generally tends to become brittle and to cause a nicked edge or the like after cutting the frozen food. However, the kitchen knives 1 of Examples 5 to 7 do not cause nicked edges because the base members are tough due to low hardness. Thus it is confirmed that the kitchen knives 1 can cut the frozen food without partially thawing the frozen food while maintaining the fine conditions of the cutting edges.

### Second Embodiment

A cutting tool including a cutting edge structure according to a second embodiment of the present invention will be described with reference to FIG. 9 and FIG. 10.

A cutting tool according to the embodiment is a kitchen knife 11 of a single grind type. The kitchen knife 11 is different from the kitchen knife 1 according to the first embodiment in that the edge 4 is provided only on one surface (the front surface side) of the cutting edge portion 5 which is the region close to the cutting edge of the blade 2. However, other features (the materials, shapes, manufacturing methods and the like of the blade 2, the handle 3, the cutting edge portion 5, the base member 6, and the cutting edge member 7 as well as the cutting edge angle θ) are similar to those of the kitchen knife 1.

Therefore, the second embodiment also exerts the operation and effect similar to the operation and effect of the first embodiment.

Although the embodiment of the present invention have been described above, it is to be understood that these embodiments are mere examples described in order to facilitate the understanding of the present invention and that the present invention is not limited only to these embodiments. The technical scope of the present invention is not limited only to the specific technical matters disclosed in conjunction with the above-described embodiments, but encompasses various modifications, alterations, substitute techniques, and the like which can be easily derived therefrom. For instance, the cutting tool is not limited only to a kitchen knife but may also be any of the knives, kogatanas, razors, gravers, sickles, chisels, planes, and the like as mentioned previously. When the present invention is applied to any of these cutting tools, the coating 7 may be formed on one surface of the base member constituting the cutting edge portion of the cutting tool by the above-described discharge surface treatment, and then the surface of the cutting edge portion on the other side of the surface provided with the coating may be sharpened to form the coating 7 in such a manner that the edge of the coating 7 projects more toward the distal end side of the cutting edge portion than the edge of the base member and that the cutting edge angle is 10° to 20°, inclusive.

This application claims the benefit of priority based upon Japanese Patent Application No. 2010-010451 filed on Jan. 20, 2010, the entire contents of which are incorporated herein by reference.

### INDUSTRIAL APPLICABILITY

According to the present invention, a cutting edge structure capable of maintaining fine sharpness even for a longer period and a cutting tool including the cutting edge structure can be obtained. Therefore, the present invention can suitably be used in various applications including kitchen knives, knives, kogatanas, razors, gravers, sickles, chisels, planes, and so forth.

### REFERENCE SIGNS LIST

δ projection amount

θ cutting edge angle

D1 retreat amount

D2 retreat amount

L processing liquid

w width

1 kitchen knife

2 blade

3 handle

4 edge

5 cutting edge portion

5a cutting edge

6 base member

6a front surface (first surface)

6b back surface (second surface)

6c front end edge

7 coating (cutting edge member)

8 discharge electrode

11 kitchen knife

1: A cutting edge structure for a cutting tool comprising:
a base member; and
a cutting edge member supported by the base member and having higher hardness than the base member, wherein
the base member includes a first surface and a second surface intersecting the first surface,
the cutting edge member comprises a coating formed by generating electric discharge between the second surface and a discharge electrode and by depositing a constituent material of the discharge electrode and a reacted substance of the constituent material on the second surface by using energy of the electric discharge, the discharge electrode being formed by molding powder of metal, powder of a metal compound, powder of a ceramic, or powder of a mixture thereof, and
the base member and the cutting edge member are formed such that an edge of the coating projects from a cross ridge line between the first surface and the second surface toward a distal end side of a cutting edge and that a cutting edge angle is 10° to 20°, inclusive.

2: The cutting edge structure for a cutting tool according to claim 1, wherein the hardness of the base member is HRC 27 to HRC 60, inclusive.

3: The cutting edge structure for a cutting tool according to claim 1, wherein the base member is made of any one of stainless steel, steel, powder steel, a composite material, and titanium.

4: The cutting edge structure for a cutting tool according to claim 1, wherein the metal, the metal compound, or the ceramic comprises titanium (Ti), silicon (Si), cubic boron nitride (cBN), titanium carbide (TiC), titanium nitride (TiN), titanium aluminum nitride (TiAlN), titanium boride (TiB), titanium diboride (TiB₂), tungsten carbide (WC), chromium carbide (Cr₃C₂), silicon carbide (SiC), zirconium carbide (ZrC), vanadium carbide (VC), boron carbide (B₄C), silicon nitride (Si₃N₄), stabilized zirconium oxide (ZrO₂—Y), or alumina (Al₂O₃).

5: The cutting edge structure for a cutting tool according to claim 1 , wherein surface roughness Ra of the coating is equal to or above 0.8 μm.

6: The cutting edge structure for a cutting tool according to claim 1, wherein the coating covers a strip-shaped region located on the second surface of the base member and having a width equal to or above 1 mm from the cutting edge.

7: A cutting tool comprising the cutting edge structure for a cutting tool according to claim 1.
